(19) United States
(12) Patent Application Publication
(10) Pub. No.: US 2017/0022912 A1
(43) Pub. Date: Jan. 26, 2017

(54) MIXED SIGNAL IC FOR USE IN AN AUTOMOBILE ELECTRONIC CONTROL UNIT

(71) Applicant: Renesas Electronics America Inc., Santa Clara, CA (US)

(72) Inventors: Gary Miller, Caseville, MI (US); Amrit Vivekanand, Saline, MI (US)

(21) Appl. No.: 15/181,104

(22) Filed: Jun. 13, 2016

Related U.S. Application Data
(60) Provisional application No. 62/174,832, filed on Jun. 12, 2015.

(51) Int. Cl. F02D 37/02; F02D 41/26

(52) U.S. Cl. CPC F02D 37/02; F02D 41/26

(57) ABSTRACT

Disclosed is an apparatus for use in an ECU. In one embodiment, the apparatus include a first microcontroller coupled to a first IC. The first IC is configured to receive and process sensor signals from respective sensors in an automobile. The first IC is configured to generate first signals in response to processing the sensor signals. The first microcontroller is configured to receive and process one or more of the first signals in accordance with instructions stored in memory of the first microcontroller. The first microcontroller is configured to generate a control signal for controlling a component, such as a spark plug, of the automobile in response to the first microcontroller processing the one or more of the first signals. The first IC is also configured to generate another control signal for controlling another component of the automobile in response to processing the sensor signals.

### BACKGROUND

The present patent application claims priority to U.S. Patent Application No. 62/174,832, filed on Jun. 12, 2015, entitled “Automotive Powertrain Configurable Architecture With Mixed Signal Power” and is incorporated by reference herein in its entirety and for all purposes as if completely and fully set forth herein.

Electronic Control Unit (ECU) is a generic term for an embedded system that controls one or more subsystems in a transport vehicle such as automobiles. The present invention will be described with reference to ECUs that control one or more subsystems in automobiles, it being understood the present invention should not be limited thereto. A modern automobile may employ dozens of ECUs.

### SUMMARY OF THE INVENTION

Disclosed is an apparatus for use in an ECU. In one embodiment, the apparatus include a first microcontroller coupled to a first IC. The first IC is configured to receive and process sensor signals from respective sensors in an automobile. The first IC is configured to generate first signals in response to processing the sensor signals. The first microcontroller is configured to receive and process one or more of the first signals in accordance with instructions stored in memory of the first microcontroller. The first microcontroller is configured to generate a control signal for controlling a component, such as an electric motor, of the automobile in response to the first microcontroller processing the one or more of the first signals. The first IC is also configured to generate another control signal for controlling another component, such as a spark plug, of the automobile in response to processing the sensor signals.

### BRIEF DESCRIPTION OF THE DRAWINGS

The present invention may be better understood in its numerous objects, features, and advantages made apparent to those skilled in the art by referencing the accompanying drawings.

FIG. 1 is a block diagram illustrating an ECU coupled between devices and components of an automobile.

FIG. 2 is a block diagram illustrating an example of the ECU shown in FIG. 1.

FIG. 3 is a diagram illustrating an example mixed signal IC employed in a powertrain control module (PCM).

FIG. 4 is a diagram illustrating a pair of mixed signal ICs employed in another PCM.

The use of the same reference symbols in different drawings indicates similar or identical items.

### DETAILED DESCRIPTION

Some modern automobiles have more than 50 ECUs. Types of automobile ECUs include Engine Control Module (ECM), Powertrain Control Module (PCM), Transmission Control Module (TCM), Brake Control Module (BCM), Suspension Control Module (SCM), etc.

Each type of ECU typically includes several integrated circuits (ICs) interconnected on a printed circuit board (PCB), ceramic substrate or a thin laminate substrate. Physical inputs to an ECU directly or indirectly receive digital and/or analog signals from devices in an automobile such as sensors, other ECUs, etc. Outputs of an ECU are directly or indirectly coupled to and control automobile components such as fuel injectors, spark plugs, solenoids, throttles, valves, actuators, etc. A housing protects the PCB and mounted ICs from environmental factors.

The ICs employed in ECUs vary depending on ECU type. However, nearly all ECUs include a microcontroller, one or more drivers and power transistors (e.g., power MOSFETs, IGBTs, etc.). The microcontroller is the heart of the ECU. Microcontrollers employed in ECUs are running hotter and increasing in size (i.e., number of devices such as gates, diodes, etc.), speed, and complexity. Managing the increasing heat, complexity, and speed of ECU microcontrollers has become a key and significant challenge for semiconductor manufacturers.

In general a microcontroller is a small computer formed on a single IC. Microcontrollers contain one or more central processing units (CPUs). Flash memory is also included in microcontrollers, as well as a relatively small amount of random access memory (RAM). Flash memory stores program code. Typically, microcontroller applications (i.e., programs) fit in the available on-chip flash memory, since it would be costly to provide a system with external, expandable program memory. Microcontrollers are designed for embedded applications, in contrast to microprocessors used in personal computers. By reducing the size and cost compared to a design that uses separate ICs for the microprocessor, memory, and peripherals, microcontrollers make it economical to digitally control devices including those in automobiles.

Microcontrollers also contain general purpose IO pins (GPIO) and dedicated peripherals. GPIO pins are software configurable to either an input or output state. When GPIO pins are configured to an input state, they can be used to read external signals. Configured to the output state, GPIO pins can control external components such as solenoids, motors, etc. Mixed signal microcontrollers have been commonly used in ECUs, integrating analog components needed to control non-digital devices. For example, microcontrollers were required to read devices such as sensors that produce analog signals. Since CPUs in microcontrollers are built to interpret and process digital data, i.e. 1s and 0s, they are not able to do anything with analog signals that may be sent to it. As such microcontrollers often included analog-to-digital converters (ADCs) to convert analog signals into digital equivalents. Additional peripherals that are generally found in microcontrollers include timers, event counters, and pulse width modulation (PWM) modules. These additional peripherals made it possible for microcontrollers to control external devices such as motors without burdening the CPU with tight software loops.

Microcontrollers employed in automobile ECUs varied in physical structure based on the type of ECU. Nearly all microcontrollers include one or more CPUs, flash memory, RAM, GPIO ports and the peripherals mentioned above. ECU microcontrollers also included additional, dedicated peripherals. These dedicated peripherals include coprocessor modules, signal conditioning modules, etc. These dedicated peripherals increased the size and complexity of microcontrollers.

A coprocessor module, as its name implies, includes a coprocessor, which can execute instructions stored in local memory. The coprocessor is used to supplement the functions of the main processor (i.e., CPU) of the microcontroller. By offloading processor-intensive tasks from the main CPU, coprocessors can accelerate system performance Coprocessors vary in their degree of autonomy from the main CPU. Some coprocessors rely on direct control via operational parameters provided by the main CPU, or coprocessor instructions that are embedded in the CPU's instruction stream. Coprocessor modules are large (i.e., contain a substantial number of gates) and occupy a substantial area of the microcontroller IC. In addition, coprocessor modules generate a substantial amount of heat albeit not as much as a CPU.

Coprocessor modules perform dedicated functions. For example, microcontrollers employed in ECMs and PCMs typically included a coprocessor module in the form of a timer module, which autonomously or semi-autonomously generates timed signals that control fuel injectors and spark plugs based on engine speed, engine temperature, etc. There are several implementations of timer modules. In one implementation (called a time processing unit or TPU) the module's dedicated coprocessor is programmable by the main CPU to fulfil the timer specific tasks. Because of the timer specific functionality, program code needed for the dedicated coprocessor often consists of timer specific instructions. This coprocessor, however, often has a lower resolution for signal processing and is hard to program because of the very special instruction sets. Another timer module implementation (referred to herein as the generic timer module or GTM) combines hardware and software approaches for controlling fuel injectors and spark plugs. There is a RISC-like programmable coprocessor inside the GTM. This coprocessor has its own internal RAM where code and data can be stored. With this coprocessor it is possible to process input signals and generate complex output signals for controlling fuel injectors and spark plugs. The RISC-like coprocessor adds flexibility to the GTM, while the instruction set is easy to understand and comparable to general purpose CPUs. The coprocessor of the GTM also requires programming by the main CPU. Microcontrollers employed in ECMs and PCMs more typically now include GTMs. In contrast, microcontrollers in other types of automobile ECUs, such as SCMs, do not include timer modules.

In addition to coprocessor modules, prior ECU microcontrollers included signal conditional modules for conditioning analog signals received from sensors or other devices. Signal conditioning means manipulating a signal in such a way that it meets the requirements of the CPU or a dedicated peripheral (e.g., GTM) for further processing. To illustrate, microcontrollers in ECMs or PCMs often included an analog filter module that filters a cylinder pressure signal provided by cylinder pressure sensor. The analog filter module provides the filtered cylinder pressure signal to an ADC for subsequent conversion. A gain/attenuation module (GAM) receives the digital cylinder pressure signal, and applies a gain to the digital cylinder pressure signal. The GAM may also attenuate the digital cylinder pressure signal to improve its accuracy. A digital filtering module receives the signal from the gain/attenuation module, and performs digital filtering of the digital cylinder pressure signal. A fast Fourier transform (FFT) module may also receive the cylinder pressure signal and generates one or more fast FFTs of the cylinder pressure signal. A knock detection module, which can be another dedicated coprocessor module, detects engine knock based on the one or more FFTs. The knock detection module can report the engine knock to the main CPU. Microcontrollers of prior ECMs and PCMs have included the signal conditioning peripherals described above (i.e., analog filter module, gain/attenuation module, digital filtering module, FFT module). Microcontrollers in other types of prior ECUs have included different types of dedicated signal conditioning peripherals.

ECU microcontrollers were designed with dedicated peripherals that provide unique functions for the ECUs in which they are employed. Some microcontrollers included GTMs, knock detection modules and FFTs, while others didn't. As a result, a microcontroller designed for use in, for example, a PCM, was not be compatible for use in a SCM, and vice versa. Moreover, the structure of microcontrollers for a specific ECU, varied according to automobile type. For example, a PCM microcontroller that was designed to control fuel injectors or spark plugs of a four cylinder engine, was not suitable for controlling fuel injectors or spark plugs of a six cylinder engine. Further, four cylinder engines can vary, and as a result a PCM microcontroller designed to control components of one type of four cylinder engine, was not suitable to control components of another type of four cylinder engine. Another problem with prior microcontrollers is that the inclusion of the dedicated peripherals such as FFTs, knock detection modules, timer modules, etc., increases the size, cost and complexity of the microcontrollers. Another problem relates to microcontroller manufacturing. To increase gate count and provide more functionality, microcontrollers are fabricated with smaller device geometries. Some of the dedicated peripherals added to ECU microcontrollers, such as sigma delta ADCs, suffer in performance when manufactured using a fabrication process with smaller geometries. In other words, a sigma delta ADC or other type of ADC, which is manufactured using a 90 nanometer fabrication process, will function more accurately than a sigma delta ADC manufactured using a 20 nanometer fabrication process. Another problem is that dedicated peripherals such as the GTM generate a substantial amount of heat. This heat and the heat generated by multiple CPUs can easily exceed limitations placed on microcontrollers if the CPUs are operated at high speed. To avoid this, unfortunately, microcontrollers were operated at less than optimal clock rates, which in turn leads to slower performance.

The present invention provides an apparatus and method for addressing the foregoing problems and others. In one embodiment, the apparatus includes an ECU, which further includes a microcontroller, a first mixed signal IC, and a communication link coupled therebetween. The microcontroller is essentially generic with respect to its physical structure, and as a result the microcontroller can be used in any one of several different types of ECUs. The mixed signal IC, however, is not a generic component. One mixed signal IC can be used in, for example, a PCM, but cannot be used in a SCM, or vice-versa. In one embodiment, the mixed signal IC may include one or more dedicated peripherals, such as an FFT or a sigma delta ADC, for conditioning signals that are received directly or indirectly from sensors or other devices in an automobile. The conditioned signals can be digitized and further processed by a coprocessor module such as a GTM of the mixed signal IC. In one embodiment the coprocessor may also capture and process input signals such as pulse width modulation (PWM) signals from devices external to the mixed signal IC. The conditioned signals may also be transmitted to the microcontroller via the data communication link for further processing in accordance with the microcontroller's embedded application. Because the mixed signal IC contains modules that were included as dedicated peripherals on prior microcontrollers, the microcontrollers of the present invention offer substantial advantages. For example, the microcontroller of the present invention should generate less heat when operating at the same speed of a prior microcontroller that includes, for example, a GTM and/or sigma delta ADC. Additional advantages are explained below.

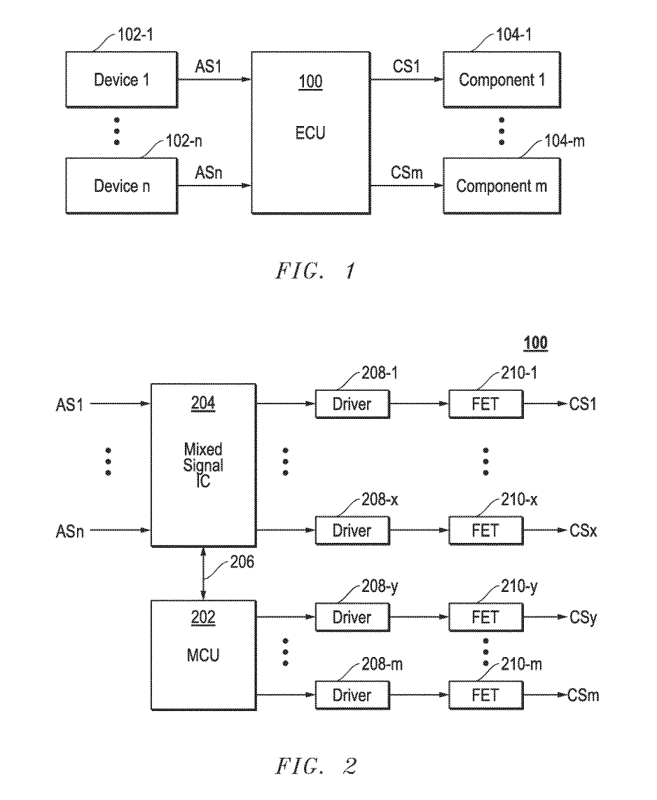

FIG. 1 illustrates an ECU 100 employing one embodiment of the present invention. ECU 100 is coupled between devices 102 and components 104 of an automobile. Devices 102 may take form in sensors or other devices, while components 104 take form in fuel injectors, spark plugs, actuators, solenoids, etc. ECU 100 receives analog signals AS1-ASn from respective devices 102. ECU 100 processes these analog signals and generates control signals CS1-CSm for controlling respective components 104.

FIG. 2 illustrates one embodiment of ECU 100. As shown, ECU 100 in FIG. 2 includes a microcontroller 202 coupled to a mixed signal IC 204 via a communication link 206. For the purpose of explanation only, link 206 takes form in a serial communication link. Additionally, ECU 100 includes drivers 208 and power transistors 210.

Mixed signal IC 204 receives analog signals AS1-ASn from respective devices 102. In one embodiment, mixed signal IC 204 includes signal conditioning modules and at least one coprocessor module (not shown in FIG. 2). The signal conditioning modules may include, for example, one or more of FFTs, ADCs including sigma-delta ADCs, filters including digital and FIR filters, etc. The signal conditioning modules receive and condition analog signals AS1-ASn for subsequent processing by microcontroller 202 and/or the coprocessor module. Along these lines, one or more of the conditioned signals in digital form can be transmitted to microcontroller 202 via link 206 for further processing in accordance with an embedded application (not shown). Microcontroller 202 processes the conditioned signals to generate control signals for controlling components 104 via drivers 208 and power transistors 210. One or more of the conditioned signals in digital form can also processed by a coprocessor module, such as a GTM, within mixed signal IC 204 for generating control signals that control components 104 via respective drivers 208 and power transistors 210. The coprocessor modules are programmable by microcontroller 202. Coprocessor modules contained within mixed signal IC 204 receive control data such as instructions or operating parameters from microcontroller 202 via link 206. The coprocessor modules operate according to the instructions, control data or operating parameters that are received from microcontroller 202. In a sense, the coprocessor modules act as slaves to the microcontroller 202.

FIG. 3 illustrates one embodiment of the mixed signal IC shown in FIG. 2. The mixed signal IC 300 shown in FIG. 3 is configured for use in a PCM, it being understood the present invention should not be so limited.

Mixed signal IC 300 includes several signal conditioning modules 310 including sigma-delta ADC 310-1, digital filter module (DFM) 310-2, gain/attenuation module (GAM) 310-3, etc. Mixed signal IC 300 also includes several coprocessor models including a GTM 312, knock detection module 314, etc. A serial port 316 enables data communication between mixed signal IC 300 and microcontroller 202. A sub processing unit, which contains CPU 320, controls data transmission on a bus between modules 312-314 and serial port 320.

As noted, mixed signal IC 300 is configured for use within a PCM for an automobile. Additional mixed signal ICs are contemplated. Although not shown, another mixed signal IC with substantially different sets of coprocessor modules and signal conditioning modules, is coupled to another microcontroller, which is substantially similar or identical to microcontroller 202, but loaded with a different application program. The combination is employed in another ECU, such as a SCM, to control a different set of automobile components.

GTM 312 controls fuel injectors and spark plugs based on one or more variables such as RPM, temperature, pulse width modulation (PWM) signals, etc., of an automobile engine to ensure optimal performance thereof. Engine RPM is monitored by a crankshaft position sensor, which plays a primary role in GTM control of fuel injection and spark plug firing. A mass air flow sensor measures the amount of air flowing into the engine through a throttle plate. An engine temperature sensor measures whether the engine is warmed up or cool. (If the engine is still cool, additional fuel will be injected.) GTM 312 may receive and process one or more sensor signals after they are conditioned by one or more of the conditioning modules 310. For example, mixed IC 300 may receive a PWM signal from an external device. GTM 312 may process the PWM signal to detect its frequency and duty cycle after it is voltage scaled from 12 volts to 5 volts by a signal conditioning module (not shown). The detected frequency and duty cycle can be further processed during the generation of signals that control the spark plugs and fuel injectors. In an alternative embodiment, the conditioning of the PWM signal or other externally generated signals that are processed by GTM 312, may be implemented by signal conditioners that are external to mixed signal IC 300. GTM 312 also receives control data in the form of instructions and/or parameters from microcontroller 202 via serial link 206. A coprocessor of GTM 312 generates control signals in response to processing one or more of the conditioned signals in accordance with the control data received from microcontroller. In FIG. 3, GTM 312 generates four fuel injection control signals and four spark plug control signals. The four fuel injection control signals control four respective fuel injectors of a four-cylinder automobile engine, and the four spark plug control signals control four respective spark plugs of the four-cylinder engine. The timing of the fuel injection and spark plug control signals can be modified on the fly.

As noted, mixed signal IC 300 is in data communication with microcontroller 202 via serial link 206. One or more of the conditioned signals generated by conditioning modules 310 can be transmitted via link 206 in digital form to microcontroller 202 for subsequent processing therein. For example, a main CPU within microcontroller 202 can process the conditioned signals in accordance with an embedded application and generate control data that is subsequently provided to GTM 312 and used therein to adjust the generation of fuel injection and spark plug control signals. For example, the microcontroller may employ a timing map (lookup table) that defines spark advance values for all combinations of engine speed, engine load, etc. The spark advance values can be transmitted to GTM 312 and used in the generation of spark plug control signals. In addition, the main CPU of microcontroller 202 can process the conditioned signals and generate control signals for controlling additional components within the automobile engine such as a cylinder valves. Some engines have variable valve timing. In the embodiment shown, microcontroller 202 controls the time in the engine cycle at which the cylinder valves open and close. Microcontroller 202 can also finely control a throttle plate in order to reduce emissions or maximize engine performance FIG. 3 illustrates at least two control signals CSx and CSm that are generated by the microcontroller 202 based on one or more conditioned signals provided by mixed signal IC 300.

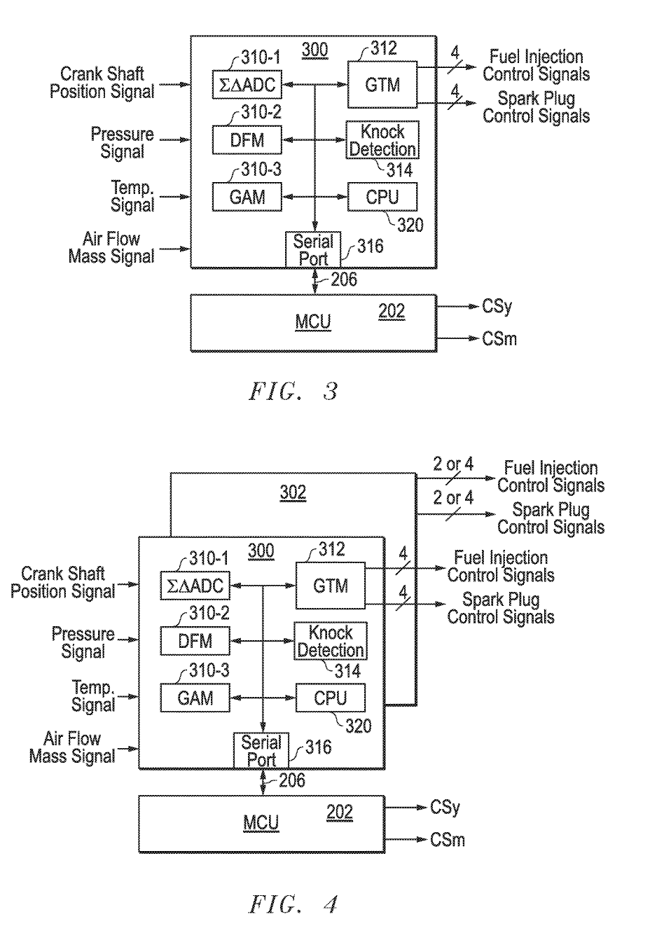

FIG. 3 illustrates relevant components of a PCM for controlling a four-cylinder engine. FIG. 4 illustrates relevant components of a PCM for controlling an eight-cylinder automobile engine. The PCM shown in FIG. 4 is substantially similar to the PCM shown in FIG. 3. One significant difference, however, is additional mixed signal IC 302 in data communication with microcontroller 202. In the embodiment, mixed signal IC 300 and mixed signal IC 302 are substantially identical in physical structure. The second mixed signal IC 302 is added in order to control the additional four fuel injectors and four spark plugs of the eight-cylinder automobile engine. Like the mixed signal IC 300 shown in FIG. 3, mixed signal IC 302 receives control data from microcontroller 202. This control data is used by GTM 412 when generating its control signals for the fuel injectors and spark plugs.

The mixed signal ICs of the present invention provide advantages when designing ECUs, many of which are described above. For example, the size and cost of microcontroller 202 can be reduced when compared to prior microcontrollers employed in ECUs since microcontroller 202 does not include signal conditioning modules and/or coprocessor modules. Or the area normally occupied by signal conditioning modules and/or coprocessor modules on a microcontroller can be replaced with one or more additional CPUs. This aspect enhances operating characteristics of the microcontroller. Compared to prior microcontrollers, microcontroller 202 with the same number of CPUs will generate less heat when operating at the same speed. Microcontroller 202 and mixed signal ICs, such as mixed signal IC 300, can be manufactured with different geometries. Automobile manufacturers continue to demand ICs that operate at higher frequencies and are capable of switching at higher speeds. In response to this demand, transistors and other devices (e.g., diodes) must be made very small, especially the junction areas of these devices, in order to enable them to be operated at the high range of frequencies and the demanded switching speeds. However, several of the signal conditioning modules, such as sigma delta ADCs, suffer in performance when they are manufactured with smaller geometries. Mixed signal ICs, such as mixed signal IC 300, can be manufactured with larger device geometries when compared to the device geometries of microcontroller 202. This enables microcontroller 202 to operate at fast speeds and signal conditioning modules of the mixed signal IC to perform more accurately. Other benefits of the present invention are contemplated.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. An apparatus comprising:
a first microcontroller coupled to a first IC;
wherein the first IC is configured to receive and process sensor signals from respective sensors in an automobile;
wherein the first IC is configured to generate first signals in response to processing the sensor signals;
wherein the first microcontroller is configured to receive and process one or more of the first signals in accordance with instructions stored in memory of the first microcontroller;
wherein the first microcontroller is configured to generate a control signal for controlling a component of the automobile in response to the first microcontroller processing the one or more of the first signals;
wherein the first IC is configured to generate a first control signal for controlling a first component of the automobile in response to processing the sensor signals.

2. The apparatus of claim 1 further comprising a second IC configured to receive and process the sensor signals, wherein the second IC is configured to generate a second control signal for controlling a second component of the automobile in response to processing the sensor signals.

3. The apparatus of claim 1 further comprising:
a first serial communication link coupling the microcontroller and the first IC;
wherein the first microcontroller is configured to generate and transmit first control data to the first IC via the first serial communication link in response to the first microcontroller processing the one or more first signals in accordance with instructions stored in memory of the first microcontroller;
wherein the first IC comprises:
a first coprocessor, and;
a first memory for storing first instructions that are executable by the first data processing unit;
wherein the first coprocessor generates the first control signal in response to receiving the first control data and in response to processing the first instructions.

4. The apparatus of claim 2:
wherein the first IC comprises:
a first data processing unit, and;
a first memory for storing first instructions that are executable by the first data processing unit;
wherein the first data processing unit generates the first control signal in response to processing the first instructions;
wherein the second IC comprises:
a second data processing unit, and;
a second memory for storing first instructions that are executable by the second data processing unit;
wherein the second data processing unit generates the second control signal in response to processing the second instructions.

5. The apparatus of claim 4 wherein the first and second ICs are identical to each other.

6. The apparatus of claim 1 further comprising:
a second microcontroller coupled to a second IC;
wherein the second IC is configured to receive and process analog signals received from respective devices in the automobile;
wherein the second IC is configured to generate second signals in response to processing the analog signals;
wherein the second microcontroller is configured to receive and process one or more of the second signals in accordance with instructions stored in memory of the second microcontroller;
wherein the second microcontroller is configured to generate a third signal for controlling a third component of the automobile in response to the second microcontroller processing the one or more second signals;
wherein the second IC is configured to generate a fourth control signal for controlling a fourth component of the automobile in response to processing the analog signals;
wherein the first and second ICs are substantially different from each other.

7. The apparatus of claim 6 further comprising:
a second serial communication link coupling the second microcontroller and the second IC;
wherein the second microcontroller is configured to generate and transmit second control data to the second IC via the second serial communication link in response to the second microcontroller processing the one or more second signals in accordance with instructions stored in memory of the second microcontroller;
wherein the second IC comprises:
a second data processing unit, and;
a second memory for storing second instructions that are executable by the second data processing unit;
wherein the second coprocessor generates the fourth control signal in response to receiving the second control data and in response to processing the second instructions.

8. The apparatus of claim 5 wherein the first control signal controls a first spark plug of an engine in the automobile, and wherein the second control signal controls a second spark plug of the automobile engine.

9. The apparatus of claim 1 wherein the first IC comprises a first signal conditioning module that generates one of first signals as a function of one of the signals from the sensors.

10. The apparatus of claim 7 wherein the first IC comprises a timer module that generates the first control signal, and wherein the second IC lacks a timer module.

11. A method comprising:
a first IC is configured receiving and processing sensor signals from respective sensors in an automobile;
the first IC generating first digital signals in response to processing the sensor signals;
a first microcontroller receiving and processing one or more of the first digital signals in accordance with instructions stored in memory of the first microcontroller;
the first microcontroller generating a control signal for controlling a component of the automobile in response to the first microcontroller processing the one or more of the first digital signals;
the first IC generating a first control signal for controlling a first component of the automobile in response to processing the sensor signals.

12. The method of claim 11 further comprising a second IC receiving and processing the sensor signals, wherein the second IC generates a second control signal for controlling a second component of the automobile in response to processing the sensor signals.

13. The apparatus of claim 11 further comprising:
the first microcontroller generating and transmitting first control data to the first IC via a first serial communication link in response to the first microcontroller processing the one or more first signals in accordance with instructions stored in memory of the first microcontroller;
wherein the first IC comprises a first coprocessor that generates the first control signal in response to receiving the first control data and processing first instructions stored in memory.

14. The method of claim 12 further comprising:
wherein the first IC comprises a first coprocessor that generates the first control signal in response to processing first instructions stored in memory;
wherein the second IC comprises a second coprocessor that generates the second control signal in response to processing second instructions stored in memory.

15. The method of claim 14 wherein the first and second ICs are identical to each other.

16. The method of claim 11 further comprising:
a second IC receiving and processing analog signals received from respective devices in the automobile;
the second IC generating second signals in response to processing the analog signals;
a second microcontroller receiving and processing one or more of the second signals in accordance with instructions stored in memory of the second microcontroller;
the second microcontroller generating a third signal for controlling a third component of the automobile in response to the second microcontroller processing the one or more second signals;
the second IC generating a fourth control signal for controlling a fourth component of the automobile in response to processing the analog signals;
wherein the first and second ICs are substantially different from each other.

17. The method of claim 16 further comprising:
the second microcontroller generating and transmitting second control data to the second IC via a second serial communication link in response to the second microcontroller processing the one or more second signals in accordance with instructions stored in memory of the second microcontroller;
wherein the second IC comprises a second coprocessor that generates the fourth control signal in response to receiving the second control data and in response to processing the second instructions.

18. The method of claim 15 wherein the first control signal controls a first spark plug of an engine in the automobile, and wherein the second control signal controls a second spark plug of the automobile engine.

19. An automobile comprising:
a plurality of fuel injectors;
a plurality of spark plugs;
a plurality of sensors;
an electronic control unit comprising:
a first microcontroller coupled to a first IC via first serial communication link;
wherein the first IC is configured to receive and process sensor signals from sensors, respectively;
wherein the first IC is configured to generate first signals in response to processing the sensor signals;
wherein the first IC is configured to transmit one or more of the first signals to the first microcontroller via the first serial communication link;
wherein the first microcontroller is configured to receive and process the one or more of the first signals in accordance with instructions stored in memory of the first microcontroller;
wherein the first microcontroller is configured to generate a control signal for controlling a component of the automobile in response to the first microcontroller processing the one or more of the first signals;
wherein the first IC is configured to generate first control signals for controlling one of the fuel injectors and one of the spark plugs in response to processing the sensor signals.

20. The automobile of claim 19 further comprising a second IC configured to receive and process the sensor signals, wherein the second IC is configured to generate second control signals for controlling another of the spark plugs and another of the fuel injectors in response to processing the sensor signals.
